(19) United States
(12) Patent Application Publication
(10) Pub. No.: US 2009/0290878 A1
(43) Pub. Date: Nov. 26, 2009

(54) Generating an Optical OFDM Signal with Reduced OSNR Requirement

(75) Inventors: Jianjun Yu, Princeton, NJ (US); Ting Wang, West Windsor, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/125,507

(22) Filed: May 22, 2008

(51) Int. Cl. H04J 14/00; H04J 11/00

(52) U.S. Cl. 398/79

(57) ABSTRACT

A method for generating an optical OFDM signal with reduced optical signal to nose ratio requirement includes separating an up-converted OFDM signal into a first part and a second part out of phase with the first part; driving a modulator with the first and second parts of the of the up-converted OFDM signal; and varying a lightwave with the modulator for generating a carrier suppressed OFDM signal having improved receiver sensitivity.

### BACKGROUND OF THE INVENTION

The present invention relates generally to optical communications and, more particularly, to generating an optical orthogonal frequency division multiplexed OFDM signal with a small optical signal to noise ratio OSNR requirement.

Orthogonal frequency division multiplexing (OFDM) OFDM technology has attracted lots of attention in last two years. It is believed that OFDM will become a strong candidate for transmission signals in the next generation long-haul and access networks because of its high spectrum efficiency and its resistance to chromatic dispersion. Single sideband modulation and coherent detection is usually employed to avoid the serious chromatic dispersion coming from the large bandwidth and long distance transmission. However, due to the large optical carrier, the single sideband modulation scheme has the low receiver sensitivity for this OFDM system. When the system uses coherent detection, an optical phase lock loop and polarization scrambler are required to control the phase and polarization for the local oscillator LO. Obviously, the coherent detection will make the receiver expensive and complex.

Referring to the prior work shown in FIG. 1, in a single sideband modulation scheme the electrical RF signals 11 are used to drive an intensity modulator 14 to generate double-side band (SSB) modulation 13. Then an optical filter 15 is used to get one sideband and the optical carrier 16, while another sideband is suppressed. The optical carrier carries optical power, therefore, the receiver sensitivity is lower or the required OSNR is higher.

Accordingly, there is a need to generate an optical OFDM with high-receiver sensitivity or small OSNR requirement and without coherent detection.

### SUMMARY OF THE INVENTION

In accordance with the invention, a method for generating an optical OFDM signal with reduced optical signal to nose ratio includes separating an up-converted OFDM signal into a first part and a second part out of phase with the first part; driving a modulator with the first and second parts of the of the up-converted OFDM signal; and varying a lightwave with the modulator for generating a carrier suppressed OFDM signal having improved receiver sensitivity. In a preferred embodiment, the modulator is direct current DC biased at V, and the first and second parts are 180 degrees out of phase. Preferably, the carrier suppressed OFDM signal has a spectrum with two peaks that are beat when detected by a high speed photo receiver and the OFDM signal is recovered thereby avoiding a local oscillator optical signal for regular coherent detection.

In accordance another aspect of the invention, an optical apparatus for generating an optical OFDM signal with reduced optical signal to nose ratio includes an electrical divider for separating an up-converted OFDM signal into a first part and a second part out of phase with the first part; and a modulator driven by the first and second parts of the of the up-converted OFDM signal for varying a lightwave to generate a carrier suppressed OFDM signal having improved receiver sensitivity. In a preferred embodiment, the modulator is direct current DC biased at V_{π} and the first and second parts are 180 degrees out of phase. Preferably, the carrier suppressed OFDM signal has a spectrum with two peaks that are beat when detected by a high speed photo receiver and the OFDM signal is recovered thereby avoiding a local oscillator optical signal for regular coherent detection.

### BRIEF DESCRIPTION OF DRAWINGS

These and other advantages of the invention will be apparent to those of ordinary skill in the art by reference to the following detailed description and the accompanying drawings, where like elements are like numbered when appearing in more than one drawing figure.

FIG. 1 is a block diagram of a prior art technique for generating an optical carrier.

FIG. 2 is a block diagram of an exemplary optical configuration for generating an OFDM signal with a small OSNR ratio in accordance with the invention.

### DETAILED DESCRIPTION

The application is directed to generating an optical OFDM with high-receiver sensitivity or small OSNR requirement and without coherent detection.

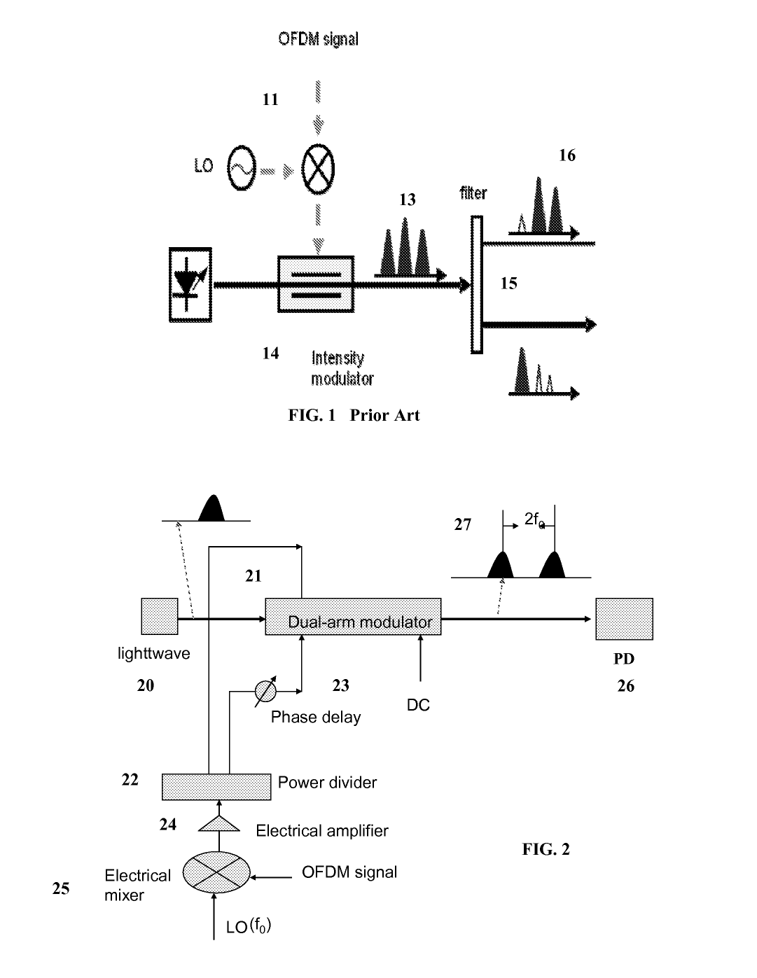

Referring to the block diagram of FIG. 1, an electrical mixer 25 is used to up-convert the OFDM signal to RF signal carried on a frequency of f₀. Then an electrical amplifier 24 is used to amplify the electrical up-converted OFDM signal. A 6 dB power divider 22 is used to separate this electrical signal into two parts 21, 23. The two parts are used to drive a dual-arm LiNbO3 external intensity modulator 23 modulating a lightwave 20. The two parts have a 180 degree phase shift that can be realized by a phase delay shifter. The intensity modulator is DC-biased at V_{π}. It means that the output power is minimal when the RF signal is turned off. In this way, a carrier-suppression OFDM signal is generated. This optical OFDM signals have the high-receiver sensitivity due to the optical carrier being suppressed. The optical spectrum 27 is shown as an insert in FIG. 1. There are two peaks. The two peaks are beat when they are detected by a high-speed photo-receiver and the baseband OFDM signal is recovered. So, a local oscillator optical signal for regular coherent detection is avoided in the inventive technique. In the receiver, the OFDM optical signal will be directly detected by a photo-detector (PD) 26.

The present invention has been shown and described in what is considered to be the most practical and preferred embodiment. It is anticipated, however, that departures may be made therefrom and that obvious modifications will be implemented by those skilled in the art. It will be appreciated that those skilled in the art will be able to devise numerous arrangements and variations which, not explicitly shown or described herein, embody the principles of the invention and are within their spirit and scope.

What is claimed is:

1. A method for generating an optical OFDM signal with reduced optical signal to nose ratio comprising the steps of:
separating an up-converted OFDM signal into a first part and a second part out of phase with the first part ; and
driving a modulator with the first and second parts of the of the up-converted OFDM signal;
varying a lightwave with the modulator for generating a carrier suppressed OFDM signal having and improved receiver sensitivity.

2. The method of claim 1, wherein the step of driving the modulator comprises a direct current DC biasing the modulator at V_{π}.

3. The method of claim 1, wherein the carrier suppressed OFDM signal has a spectrum with two peaks.

4. The method of claim 1, wherein the carrier suppressed OFDM signal has a spectrum with two peaks that are beat when detected by a high speed photo receiver and the OFDM signal is recovered.

5. The method of claim 1, wherein the carrier suppressed OFDM signal has a spectrum with two peaks that are beat when detected by a high speed photo receiver and the OFDM signal is recovered thereby avoiding a local oscillator optical signal for regular coherent detection.

6. The method of claim 1, where the separating step is preceded by mixing a local oscillator signal with an OFDM signal for generating the upconverted OFDM signal.

7. The method of claim 1, wherein the separating step comprises employing a power divider to separate the upconverted OFDM signal into the first part and the second part.

8. The method of claim 1, wherein the first and second parts of the upconverted OFDM signal are 180 degrees out of phase of each other.

9. An optical apparatus for generating an optical OFDM signal with reduced optical signal to nose ratio comprising the steps of:
an electrical divider for separating an up-converted OFDM signal into a first part and a second part out of phase with the first part; and
a modulator driven by the first and second parts of the of the up-converted OFDM signal for varying a lightwave to generate a carrier suppressed OFDM signal having improved receiver sensitivity.

10. The optical apparatus of claim 9, wherein the modulator is direct current biased at V_{π}.

11. The optical apparatus of claim 9, wherein the carrier suppressed OFDM signal has a spectrum with two peaks that are beat when detected by a high speed photo receiver and the OFDM signal is recovered.

12. The optical apparatus of claim 9, wherein the carrier suppressed OFDM signal has a spectrum with two peaks that are beat when detected by a high speed photo receiver and the OFDM signal is recovered thereby avoiding a local oscillator optical signal for regular coherent detection.

13. The optical apparatus of claim 9, a mixer for mixing a local oscillator signal with an OFDM signal for generating the upconverted OFDM signal.

14. The optical apparatus of claim 9, further comprising a power divider for separating the upconverted OFDM signal into the first part and the second part.

15. The optical apparatus of claim 9, wherein the first and second parts of the upconverted OFDM signal are 180 degrees out of phase.
